(19) United States
(12) Patent Application Publication
(10) Pub. No.: US 2018/0247622 A1
(43) Pub. Date: Aug. 30, 2018

(54) CYMBAL COVER

(71) Applicants: Cory James Evans, Kamloops (CA); Maria Josephine Evans, Kamloops (CA); Gordon Deane Worts, Penticton (CA); Wanda Joanne Worts, Penticton (CA)

(72) Inventors: Cory James Evans, Kamloops (CA); Maria Josephine Evans, Kamloops (CA); Gordon Deane Worts, Penticton (CA); Wanda Joanne Worts, Penticton (CA)

(21) Appl. No.: 15/443,943

(22) Filed: Feb. 27, 2017

(51) Int. Cl. G10G 7/00

(52) U.S. Cl. CPC G10G 7/005

(57) ABSTRACT

A cymbal cover and method of using a cymbal cover are provided that can allow for more complete coverage of a cymbal and that allow easy application and removal from a cymbal with minimal requirement for one to handle the cymbal directly with their hands. A cymbal cover comprises a resiliently stretchable, flexible cup-shaped body having a closed circular top and an open bottom defining an internal cavity and a bottom opening, a resiliently stretchable aperture disposed on the closed circular top, and a gathered closure mechanism adjacent the bottom opening. A method of using a cymbal cover comprises the steps of providing a cymbal, stretching a resiliently flexible cup-shaped body over the cymbal, and engaging a closure mechanism adjacent a bottom opening of the cup-shaped body to draw the bottom opening together on an underside of the cymbal.

### FIELD OF THE DISCLOSURE

The present disclosure generally relates to covers for percussion instruments, and in particular, relates to a device and a method for protectively covering cymbals.

### BACKGROUND

A musical cymbal is a metal disc typically of 6 to 26 inches in diameter that is struck on an upper major surface, bow, or an edge with a drumstick, mallet, brush, or other appropriate striking utensil. The cymbal typically includes a curved bell portion near its center and a substantially flat portion around its periphery.

The cymbal is typically mounted to and supported on a cymbal stand. Centrally located in the bell portion of the cymbal is an opening which is adapted to receive the upright member of the cymbal stand therethrough. The upright member of the cymbal stand includes an annular shoulder which supports a felt ring. The cymbal is supported on the felt ring and a felt washer is disposed above the cymbal. A wing nut secures the cymbal to the upright portion of the cymbal stand. The cymbal is in this way suspended via the central hole or opening on the cymbal bell by the cymbal stand.

Striking of the cymbal on its flat portion by a percussion stick sets up a vibration in the cymbal and establishes a musical tone.

Over time, cymbals can get damaged or dirty. During set up and take down of percussion sets, the cymbals are constantly handled by bare hands to remove them from the cymbal stand and to reapply them thereon. Sweat can cause corrosion and finger marks can dull the sound and spoil the overall appearance of the cymbal. They are also often stored in cases overtop of one another, causing metal-to-metal scuffing of the cymbals. Over time, wear in the case can cause metal to scuff and logos to blur. Even when a percussion set is not in use, cymbals can be subject to damage, as the cymbal disposed on a cymbal stand as part of an unused percussion set can collect dust and even oils from the air. The more contaminants that get on to the cymbal, the more likely it is that the contaminants will tarnish the cymbal's finish as well as dull the resonance, thus reducing sound quality from the cymbal.

To address these issues, many people regularly use chemical cleaners to clean off dust, dirt, and oils from the cymbals. However, such cleansers do not address the scuffs and scrapes that cymbals are prone to and each time a chemical cleaner is used on the cymbal, it also removes metal alloy, thus changing the factory specifications of the cymbal when it was lathed.

To reduce the number of times that it is necessary to clean the cymbal of contaminants using a chemical cymbal cleaner, some percussionists and drummers place plastic bags, t-shirts or towels over their cymbals to protect their cymbals. Others simply stack cymbals on top of one another other inside a cymbal bag. However, these methods still leave the cymbals prone to metal-to-metal scuffing.

Some covers for cymbals have been developed in the past; however, these cymbal covers are usually very difficult and complex to remove from the cymbal and can require significant handling of the cymbal with bare hands in order to apply and remove the conventional cymbal covers. The more the cymbal needs to be handled while applying or removing a cymbal cover, the more the cymbal is exposed to damaging dirt and oils from a person's hands. For example, rubber sound-dampening covers for cymbals are not ideal for use as a protective cymbal cover for transportation or storage, as these covers stick to the cymbals and are snugly placed around the same so that they do not move when struck with a percussion stick. To place the rubber cover on the cymbal, one must tightly stretch a piece of rubber over the edges of the cymbals, requiring one to have a firm grip on at least an edge of the cymbal while the rubber is tightly stretched around its circumference. Similarly, to remove a rubber cover, one must re-stretch the rubber cover by pulling at an edge so that the cymbal is released by the rubber lip. Both of these actions require one to have a tight grip directly on the cymbal, which can result in the transfer of damaging oils onto the surfaces of the cymbal.

Some conventional cymbal covers have felt bells to go over the central opening of the cymbal and require one to remove the wing nut, washer, and felt ring in order to put the cymbal cover on the cymbal. Again, this requires one to handle the cymbal while the cymbal is not covered by any protective covering, thus exposing the same to dirt and oils from a person's hands. Furthermore, many such covers to do not allow for the cymbal to be stored unused on the cymbal stand while covered from dust and harmful contaminants in the air.

Other conventional cymbal covers leave areas of the cymbal exposed to the environment, such as a majority of the underside of the cymbal, the upper surface of the bell portion of the cymbal, or even a section of the substantially flat surface of the cymbal. These sections that remain exposed are thus still prone to scratching, dents, and collecting dust, oil, and dirt.

It would be advantageous to have a cymbal cover that can prevent damage to cymbals from scratches and dents during set up and tear down of a drum set and during storage and transportation of the cymbals, that can maintain them in a clean and good condition, and to keep them sounding their best. It would be advantageous if such a cymbal cover could be easy to apply to a cymbal and to remove from a cymbal, with minimal direct hand contact with the cymbal required.

### SUMMARY

It is an objective of this disclosure to provide a cymbal cover and method that provides more complete coverage of a cymbal and that allows easy application and removal from a cymbal with minimal requirement for one to handle the cymbal directly with their hands. A stretchable and low-friction material, stretchable aperture at the top, and a gathered closure mechanism at the bottom can allow the cymbal cover to be applied to and removed from a cymbal with ease. The cymbal cover and method can reduce the likelihood of smudges from oily or sticky fingers on the cymbals during setup and takedown of a percussion set and can reduce metal-to-metal contact of cymbals with one another during storage and transportation.

According to one aspect of the present invention, a cymbal cover is provided comprising: a resiliently stretchable, flexible cup-shaped body having a closed circular top and an open bottom defining an internal cavity and a bottom opening; a resiliently stretchable aperture disposed on the closed circular top; and a gathered closure mechanism adjacent the bottom opening.

According to another aspect, a method of using a cymbal cover is provided comprising the steps of providing a cymbal; stretching a resiliently flexible cup-shaped body over the cymbal; and engaging a closure mechanism adjacent a bottom opening of the cup-shaped body to draw the bottom opening together on an underside of the cymbal.

The cymbal cover can be placed on the cymbal without the need to remove the wing nut, felt washer, or felt ring prior to application to or removal from the cymbal. This allows the cymbal cover to be applied to the cymbal before the cymbal is handled or removed from the case or the cymbal stand, thus preventing the need for direct contact by a person's hand. The cymbal cover can similarly be removed from the cymbal with little or no direct contact by a person's hand with the cymbal itself. The cymbal cover can thus allow one to handle a cymbal without using gloves and still keep the cymbal free of finger prints, dirt, oil, and dust. The cymbals can be handled confidently, reducing the chance of accidentally dropping one and minimizing the chances or severity of damages should one fall.

### BRIEF DESCRIPTION OF THE DRAWINGS

While the invention is claimed in the concluding portions hereof, example embodiments are provided in the accompanying detailed description which may be best understood in conjunction with the accompanying diagrams where like parts in each of the several diagrams are labeled with like numbers, and where:

FIG. 1 is a top plan view of a cymbal cover in an aspect;

FIG. 2 is a bottom plan view of the cymbal cover shown in FIG. 1;

FIG. 3 is a top plan view of the cymbal cover shown in FIG. 1 applied to a cymbal on a cymbal stand;

FIG. 4 is a side elevation view the cymbal cover applied to a cymbal on a cymbal stand as shown in FIG. 3 in an open configuration;

FIG. 5 is a bottom plan view of the cymbal cover applied to a cymbal on a cymbal stand as shown in FIG. 3 in a closed configuration; and

FIG. 6 is a side elevation view of the cymbal cover applied to a cymbal on a cymbal stand as shown in FIG. 5.

### DETAILED DESCRIPTION

The cymbal cover of the present invention can allow a percussionist or drummer to removeably cover their cymbals with a lightweight fabric, thus protecting each individual cymbal from finger oil, dirt, dust or any other contaminants that could be transferred on to the cymbal when touched with a bare hand or when exposed to the environment. The cymbal cover can protect a cymbal from marking, corrosion, and scuffs when not in use and during setup and tear down of a drum set. The cymbal cover can also reduce noise when the cymbals are packed together and can make them easier to handle. They can furthermore stop the cymbals from rubbing together while in their cymbal case.

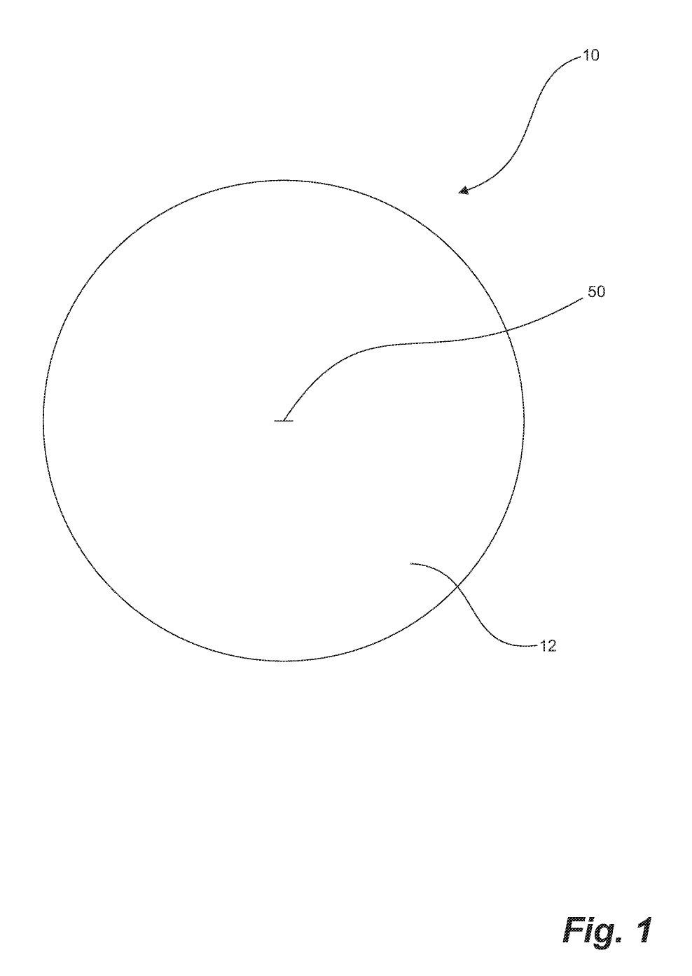

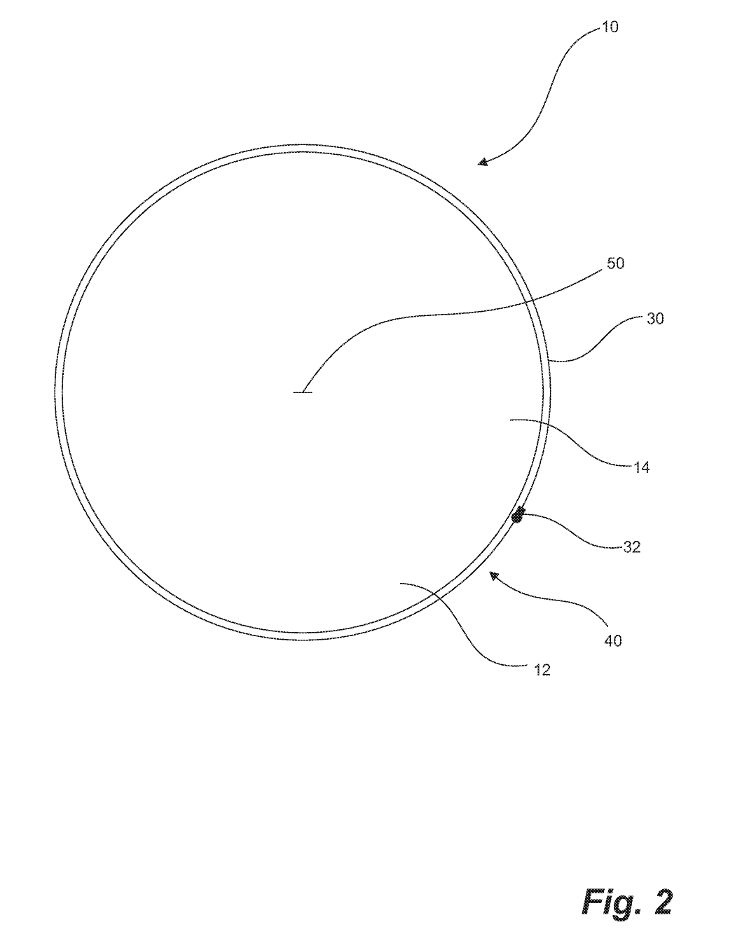

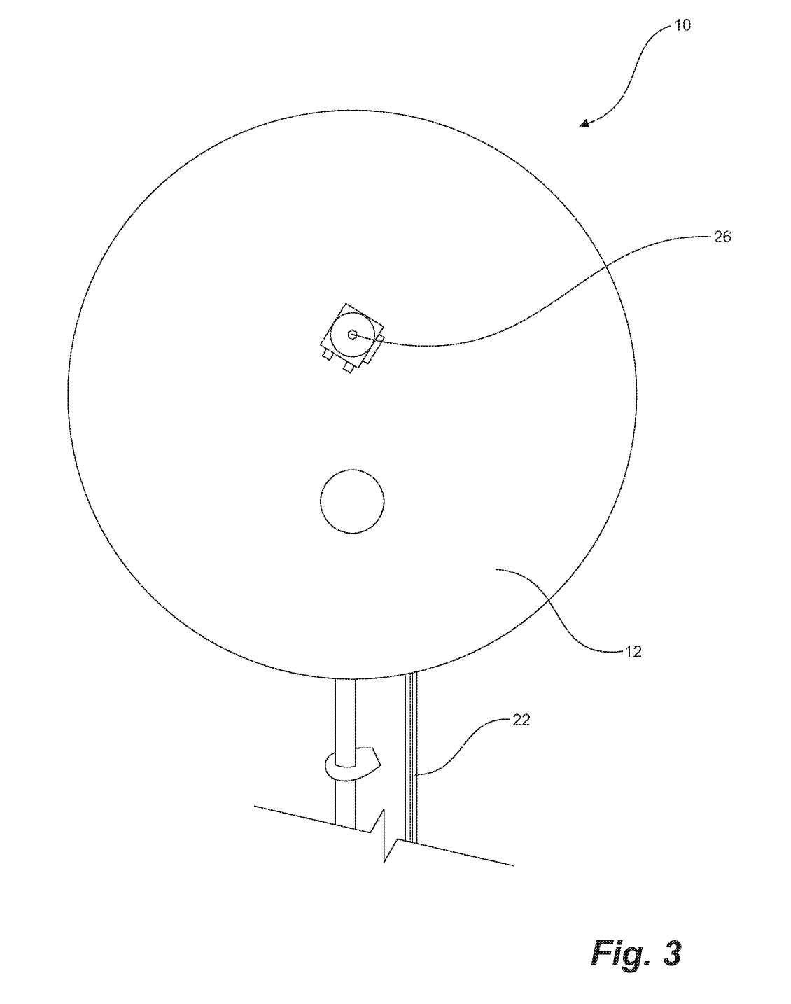

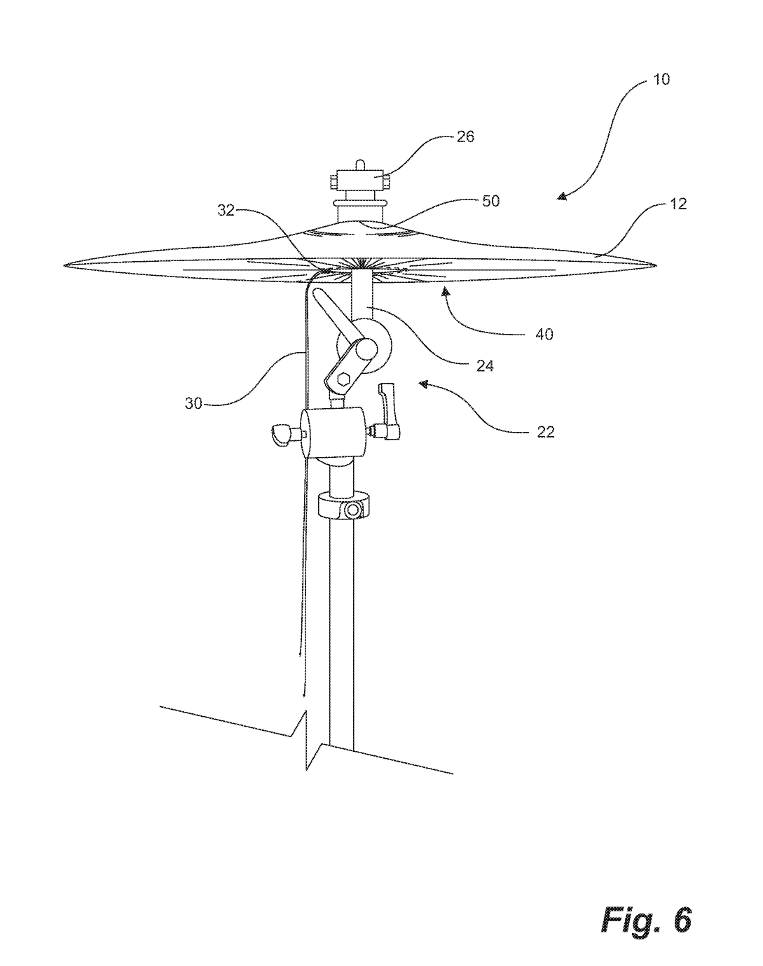

Referring to FIGS. 1 and 2, a cymbal cover 10 is shown in an aspect. As shown in FIGS. 3, 4, 5, and 6, the cymbal cover 10 can be applied to a cymbal 20 supported on a cymbal stand 22.

The cymbal 20 is a metal disc of a diameter which may be found in many commercial or popular style drum sets, ranging in diameter generally from 6 to 26 inches. It generally includes a curved bell portion near its center and a substantially flat portion around its periphery. Centrally located in the bell portion of the cymbal 20 is an opening which is adapted to receive the upright member 24 of the cymbal stand 22 therethrough. The upright member 24 includes an annular shoulder which supports a felt ring. The cymbal 20 is supported on the felt ring and another felt washer is disposed above the cymbal 20. A suitable nut or wing nut 26 is provided for securing the cymbal 20 to the upright portion 24 of the stand 22. The cymbal 20 in this way is typically pivotally mounted on the upper end portion of a vertical shaft or column 24 of the cymbal stand 22.

Base of Material

The cymbal cover 10 comprises a body 12 made out of a flexible, stretchable material. In some aspects, the material can also be a lightweight material so that it does not significantly add to the weight of the cymbals 20 when the cymbals 20 are being transported.

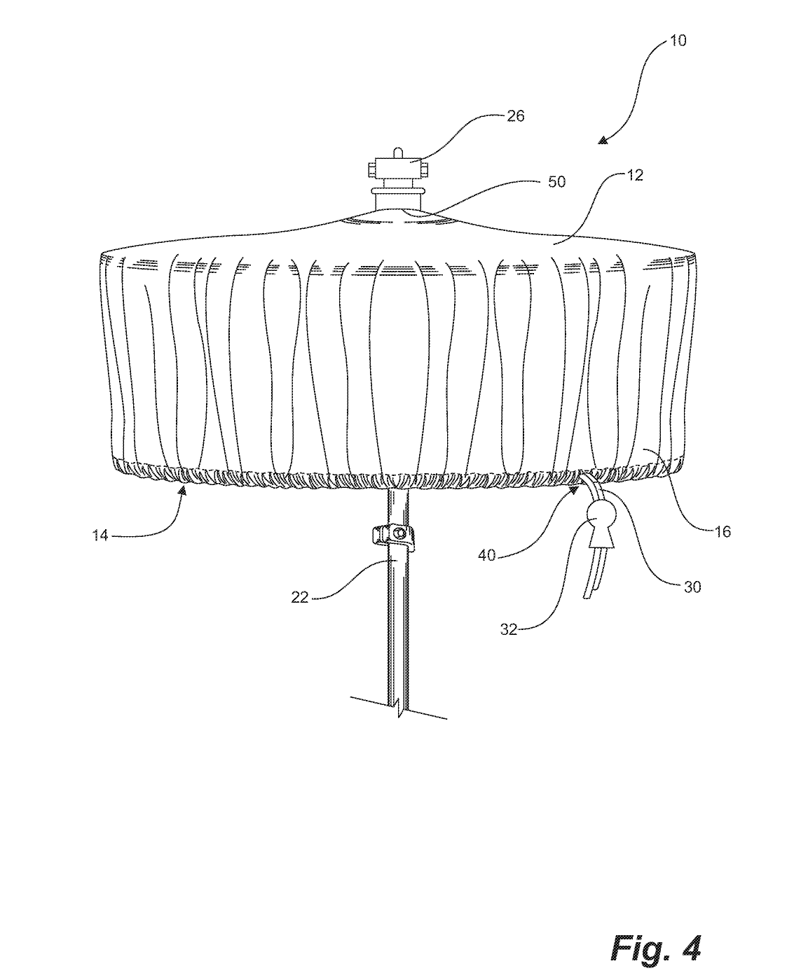

Body 12 is a generally upside-down cup-shaped sleeve with a closed circular top surface and an open bottom when in an open configuration, as shown in FIG. 4. The body 12 defines an internal cavity 14 with an opening 16 at its open bottom providing access to the internal cavity 14. The cymbal 20 can be received through the opening 16 and into the internal cavity 14 such that the upper surface of the cymbal 20 is covered by the body 12.

The closed circular top surface of the body 12, other than the aperture 50 (described in more detailed herein), can provide an unbroken base of material that extends to a diameter greater than or substantially matching that of the cymbal 20 to which it is to be applied when in a stretched configuration. In this way, the cover 10 can cover the entire topside of the cymbal 20. This provides a smooth and even topside surface for easy stacking of cymbals 20 and reduces the chances of the material catching on corners or edges of items or otherwise leaving a space wherein fingerprints and dust can settle on the topside of the cymbal 20.

Blanks may be used to form the cover 10. Blanks could include a circular sheet of material to form the closed circular top surface and a cylindrical body of material could be used to define the sides of the internal cavity 14. The blanks could then be connected together by attaching the periphery of the circular sheet of material to the periphery of one of the open ends of the cylindrical body of material through stitches, glue, or other attachment means. In other aspects, however, seams along the outer periphery of the cover 10 can be avoided by manufacturing the body 12 using a single unitary base of material, as shown in FIGS. 1-6.

The body 12 is made out of a material that has significant elasticity to allow the cover 10 to stretch, thus allowing the cymbal 20 to be inserted into the internal cavity 14 of the cover 10. The highly elastic properties of the material can allow a snug fit over the cymbal 20.

In some aspects, the body 12 is made out of a woven or knitted material having two-way stretch, and in some other aspects, it is made out of material having four-way stretch.

The material making up the body 12 could be any elastomeric or resilient material having significant stretch capability with a low-friction face on the inner surface facing the internal cavity 14. In some aspects, the elastomeric material making up a major portion of the cover 10 could be 90% polyester/10% elastane and in other aspects, could be made from an 80%/20% blend of nylon/spandex material, similar to material making up a bathing suit. In other aspects, the material could be stretch & spandex fabric, Lycra™, lurex, viscose, knitted jersey stretch fabric such as silk, elastane, or Lycra™ or spandex fabric blends. The material making up the body 12 could in some aspects be much more durable than cotton. The material could be machine washable and in some aspects will not have the potential to shrink when dried.

The material making up the body 12 is also a low-friction fabric material, such as a stretchable nylon, to allow for ease of insertion of the cymbal 20 into the cymbal internal cavity 14. The stretchable nature of the body 12 and the low-friction material can allow the cover 10 to easily move along and be stretched across the top surface of the cymbal 20 to allow for a snug fit therearound, and can allow for slight displacement of the cover 10 along the cymbal surfaces when it is closed around the lower surface of the cymbal 20, such that the cover 10 does not get stuck on the cymbal 20 when it is applied thereon or closed therearound.

In some aspects, the body 12 may be made of a multi-layer, stretchy, flexible material including a low-friction fabric on an inner surface facing the internal cavity 14, and a more durable fabric layer on an outer surface opposite the inner surface 14. In any case, the material facing the internal cavity 14 and thus potentially contacting a cymbal 20 will be low-friction to allow the cover 10 as a whole to easily slide over the cymbal 20 and be secured around it, without getting stuck against the same.

Size

The body 12 has a generally unbroken circular sheet of material (other than the aperture 50, described in more detailed herein) that will cover the upper surface of the cymbal 20 and fall down over the circular cymbal 20 edge. An aperture 50 in the circular sheet of material can permit receipt over the top of the upright member 24 of the cymbal stand 22 as well as the nut 26 and any felt rings. The aperture can be adapted to snugly fit around the upright member 24 of the cymbal stand 22, the nut 26, and/or any felt rings due to its elastic nature (as will be described in further detail herein). The aperture 50 can be stretched around and over the top of the stand 22 and washer and wing nut 26.

The body 12 of the cover 10 can be made available in various sizes to fit snugly around cymbals 20 of different sizes. For example, the unbroken circular sheet of material, when in a stretched state, could be produced in various sizes, with a diameter substantially equal to or slightly greater than the diameter of the cymbal 20 to which it is to be applied. In some aspects, the diameter of the unbroken circular sheet of material, when in a stretched state, ranges in diameter from 6 inches to 26 inches.

Generally, the body 12 covers a major portion of the upper surface of the cymbal 20. In some aspects, the closed circular top surface of the body 12 is adapted to overlie and be in substantially continuous contact with the upper surface of the cymbal 20. The cymbal cover 10 has a diameter which is approximately equal or slightly larger to the diameter of the cymbal 20 when the cymbal cover 10 is in a stretched state. This can allow the cover 10 to maintain substantially the entire upper surface of the cymbal 20 covered with the material of the body 12.

The generally unbroken circular sheet of material will extend from the aperture 50 over the entire cymbal 20 upper surface toward the outer edge of the cymbal 20's circumference. The body 12 can then fall down over the circumferential edge of the cymbal 20 to form the cylindrical sides of the generally upside-down cup-shaped sleeve when an in open configuration, as shown in FIG. 4. As described hereinbefore, the generally unbroken circular sheet of material can be a separate sheet of material from the sides of the body 12 forming the generally upside-down cup-shaped sleeve and could be assembled together through seams, or the entire body 12 could be manufactured as a single unitary body from a single base of material. The opening 16 at the body's open bottom provides access to the internal cavity 14 and when a cymbal 20 is disposed therein, the side portion of the body 12 can be drawn under the cymbal 20 edge, with a gathered closure mechanism 40 (described further herein) drawing the opening 16 together so as to allow the side portion of the body 12 to be drawn against the underside of the cymbal 20. In this way, the side portion of the body 12 that hangs over the circumferential edge of the cymbal 20 extends back onto the lower surface of the cymbal 20.

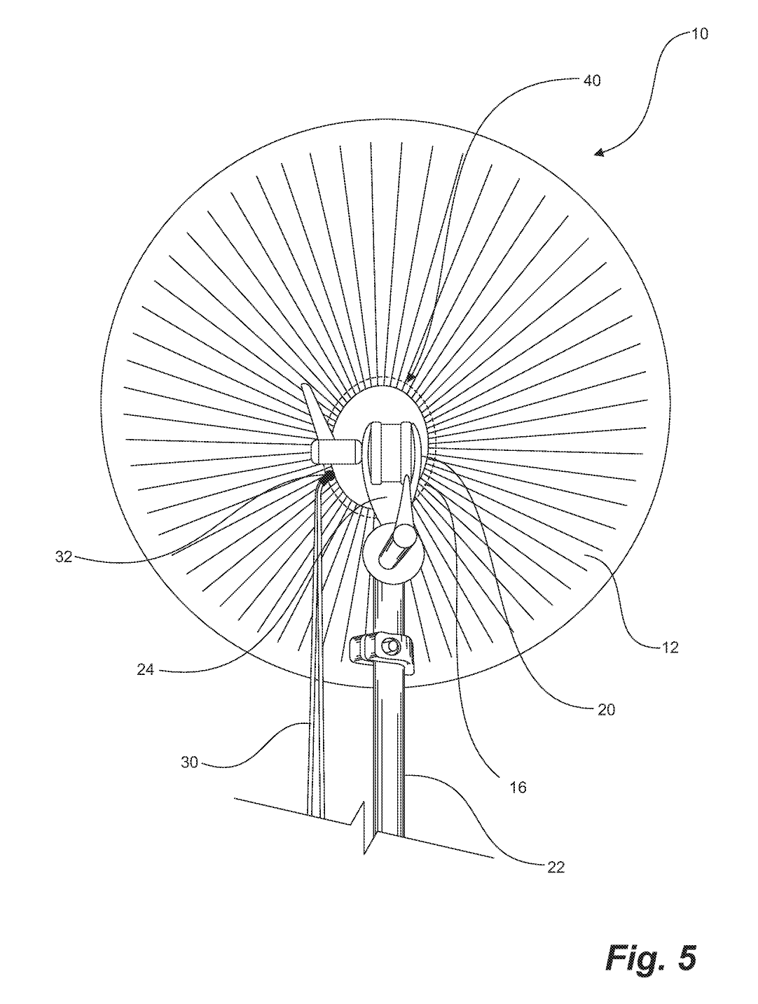

The geometry and dimensions of the side portion of the body 12 that hangs over the circumferential edge of the cymbal 20 can be made long enough such that when the gathered closure mechanism 40 is in a closed configuration, the side portion of the body 12 can be drawn up to substantially cover the entire portion of the underside of the surface of the cymbal 20, while leaving a space for the upright portion 24 of the stand 22 to fit within the space created by the drawn-in opening 16. In some aspects, the drawn-in opening 16 can fit snugly around the upright portion 24 of the stand 22, although in other aspects such as the one shown in FIG. 5, there can be a small space between the drawn-in opening 16 and the upright portion 24 of the stand 22.

In some aspects, engaging the gathered closure mechanism 40 can require the body 12 to stretch against the upper surface and/or circular edge of the cymbal 20. Due to the low-friction nature of the material making up the body 12, such stretching action does not substantially hinder the working of the cover 10 and the closure of the same over the cymbal 20.

Upper Aperture

The aperture 50 in the cymbal 20 upper surface comprises a resiliently stretchable aperture sized to stretch and fit over the top of the stand 22, any washers, and wing nut 26. The aperture 50 is also sized so as to fit snugly against the sides of the stand 22, any washers, and wing nut 26 when in place over the cymbal 20. In some aspects, the aperture 50 could be made out of a separate elastic material as the body 12, though in other aspects such as that shown in FIGS. 1-6, the aperture 50 is made out of the same material as the body 12 and is continuous and unitary with the same.

Aperture 50 is sized and shaped so as to permit receipt therethrough of the top of the stand 22, any washers, and wing nut 26 such that the cover 10 may be placed over the upper end of the supporting column 24 and brought down into a snug intimate contact with the upper surface of the cymbal 20. In this manner, the cymbal cover 10 can be attached concentrically to the cymbal stand 22 so as to overlie the upper surface of the cymbal 20, as shown in FIG. 4.

In an aspect, the aperture 50 is a single slit or cut in the center of the body 12's circular sheet of material that can be pulled open due to the elasticity of the material. This single slit or cut could measure, in an aspect, about 1-⅝ inches in length to allow the slit to stretch open and fit over top of the stand 22, any washers, and wing nut 26. In the aspect shown, the aperture 50 can slip underneath the felt ring to allow the cover 10 to substantially cover the entire upper surface of the cymbal 20.

It is understood, however, that other sizes of apertures may be used, so long as the aperture is sized large enough that in a stretched state it may fit over top of the stand 22, any washers, and any wing nuts 26, and so long as it can fit snugly around the same when the cover is disposed on a cymbal 20 that is supported on a stand 22. For example, in some aspects, the aperture could be an annular member formed from a resilient material having an unstretched diameter approximately equal to the diameter of the upright member 24 of the cymbal stand 22 and stretchable to fit over the top of the same when the cover is being applied to or removed from the cymbal 20. In yet other aspects, the aperture could be a slit comprising overlapping edges of material that can be stretched apart to accommodate upright member 24, washer, and the wing nut 26.

Gathered Bottom

A gathered closure mechanism 40 is provided along or adjacent the opening 16 at the body 12's open bottom. This gathered closure mechanism 40 can be a mechanism that gathers the opening 16 at the body 12's open bottom together to a closed position, as shown in FIG. 5. When the outer edge portion of the cover 10 falls over the outer edge of the cymbal 20's circumference, the engagement of the gathered closure mechanism 40 can fold the cylindrical sides of the generally upside-down cup-shaped sleeve under the cymbal 20 circumferential edge, with the opening 16 drawn together to form an opening that can fit the stand 22 and the outer edge portion of the cover 10 covering a majority of the periphery of the underside of the cymbal 20.

The gathered closure mechanism 40 is a mechanism that draws material together. For example, the gathered closure mechanism 40 could be an elasticized portion or edging around the opening 16 that permits the opening 16 to expand to be configured to receive the cymbal 20 therethrough into the internal cavity 14 of the body 12. The elasticized portion or edging could be made out of an elastic band connected around the opening 16 that is able to expand to allow the cymbal 20 to be inserted into the opening 16 and then contracts to secure the cover 10 in place around the cymbal 20, with the opening 16 drawn up to or near the cymbal stand 22. An elastic in this way can draw the stretchy material of the body 12 underneath the cymbal 20 and hold the cover 10 firmly in position. The top of the cymbal 20 can be fully covered and drawing the material to a close underneath the cymbal 20 allows the underside of the cymbal 20 to receive substantial coverage, as well.

The cover 10 may include a different or additional gathered closure mechanism 40 for this purpose, such as a cinch or a drawstring. As shown in FIGS. 2, 4, 5, and 6, a drawstring 30 with a cord lock 32 can be used as the gathered closure mechanism 40. In other aspects, the gathered closure mechanism 40 could comprise both a drawstring and an elastic band. The elastic band could allow for a quick and efficient gathering of material on the underside of the cymbal 20, while the drawstring could tighten the same to close around the cymbal stand 22.

In the aspect shown in FIGS. 2, 4, 5, and 6, the drawstring 30 is threaded through a hem or casing along a periphery of the cover 10, although in other aspects, the drawstring 30 could be applied to the cover 10 through the use of eyelets disposed adjacent the periphery of the cover 10 or could simply be stitched directly adjacent the periphery of the cover 10.

The drawstring 30 can be any elongate flexible material, including string, cord, lace, rope, or the like, and which can be used to draw, gather, or shorten fabric along the opening 16 of the cover 10. The drawstring 30 can be loose when not being used, and can be tightened when needed during use. The drawstring 30 can be drawn to a close to draw the periphery or opening 16 of the cover 10 together and tighten the same in a closed position, such that the bottom of the cymbal 20 is substantially covered, such as is shown in FIG. 5. This drawstring 30 can allow the cover 10 to be secured and cover more fully the bottom of the cymbal 10 than might otherwise be the case with the use of only an elastic portion. This would particularly be the case for covers 10 to be applied to larger cymbals, as the elasticity of any elastic band may not be great enough to allow for a wide enough opening 16 to accommodate the cymbal 20 therethrough, while also resiliently drawing the opening 16 to a tight close.

The drawstring 30, on the other hand, can draw the opening 16 to a further close, with or without an elastic band, and can thus provide more protection for the underside of the cymbal 20 and prevent slippage. In some aspects, a drawstring 30 can be provided as the only gathered closure mechanism 40, while in other aspects, the drawstring 30 can be provided in addition to other gathered closure mechanisms 40, such as an elastic band around the opening 16. In some aspects, the drawstring is a stretch cord that draws in the opening 16 of the cover 10 and can tie off the opening 16 around the stand 22.

The ends of the drawstring 30 can be tied to hold it in place and close up the circular opening 16. In some aspects, such as the one shown in FIGS. 1-6, the drawstring 30 can be kept drawn using a cord lock 32. The cord lock 32 can be a cord fastener, plastic stopper, cord toggle, or the like, which attaches to the drawstring 30 and tightens it without the use of knots so as to allow the cymbal cover 10 to be drawn closed and tightened quickly, as well as released and loosened quickly and easily. The cord lock 32 can comprise a barrel, a toggle, and a spring which, when squeezed together, can release tension and can allow the cord lock 32 to move freely up and down the drawstring cord 30. When released, the tension is engaged and the cord lock 32 stays in place. The cord lock 32 can be used to retain the drawstring 30 in a tightened condition around the cymbal stand 22 so as to temporarily close the cymbal cover 10 and to release the cord segment 30 when desired. In this manner, the cover 10 is tightened to a snug fit with the drawstring 30 and slider clip 32 underneath the cymbal 20, thus protecting both the upper surface of the cymbal 20 and a majority of the underside of the cymbal 20.

In Use

Each cymbal cover 10 provides a flexible body 12 that can be removably positioned over a single individual cymbal 20. The cover 10 can be placed directly on the cymbal 20 when the cymbal 20 is free from the stand 22, but can also be applied to the cymbal 20 while still on its stand 22. One does not need to remove any winged nuts 26 or washers or the like prior to applying the cymbal cover 10 to the cymbal 20. Similarly, when removing the cover 10 from the cymbal 20, one can maintain the cymbal 20 on its stand 22 along with the security of the winged nut 26 and washers to keep the cymbal 20 from accidentally slipping off of its stand 22 and falling to the floor, where it can be dented.

To use the cymbal cover 10, the cymbal 20 can be received through the opening 16 and into the internal cavity 14. If the cymbal 20 is supported on a cymbal stand 22, the aperture 50 can be stretched to allow the upright member 24, washer, and the wing nut 26 therethrough and the resiliency of the aperture 50 can allow the aperture to close once the stretching force is released, allowing the aperture 50 to close underneath the felt washer and to fit snugly against the cymbal stand 22 or nut 26. The generally unbroken circular sheet of material will extend from the aperture 50 over the entire cymbal 20 upper surface toward the outer edge of the cymbal 20's circumference. The body 12 can then fall down over the circumferential edge of the cymbal 20 to form the cylindrical sides of the generally upside-down cup-shaped sleeve when an in open configuration, as shown in FIG. 4. When the outer edge portion of the cover 10 falls over the outer edge of the cymbal 20's circumference, the engagement of the gathered closure mechanism 40 can fold the cylindrical sides of the generally upside-down cup-shaped sleeve under the cymbal 20 circumferential edge back toward the direction of the aperture 50, with the opening 16 drawn together to form a drawn-in opening that can fit the stand 22 and the outer edge portion of the cover 10 covering a majority of the periphery of the underside surface of the cymbal 20. A tight closure of the cover 10 around the cymbal 20 can be provided because of the low-friction material facing the internal cavity 14 of the body 12 that allows free movement of the cover 10 over the surfaces of the cymbal 10 and the stretchable nature of the material of the body 12 that allows the aperture 50 to stretch around the cymbal stand 22 and nut 26 and allows the body 12 to stretch over the circumferential edges of the cymbal 20. In an aspect, a drawstring 30 is used as at least one gathered closure mechanism 40, and a cord lock 32 can be used to tighten the gathered material around the stand 22 and lock the same in place.

In some aspects, once the cover 10 is applied to the cymbal 20, the cymbal 20 along with the cover 10 can be together removed from the stand 22 and placed into either a soft or hard shell cymbal case, with the cymbals 20 protected by the cover 20 stacked one on top of the other, without having any cymbal-to-cymbal contact in the case. By allowing the cymbal cover 10 to be applied to the cymbal 20 while on the stand 22, there is little or no need for a user's hands to touch the cymbal 20 itself, as the cymbal cover 10 needs only to be stretched in place over top of the cymbal 20, and the gathered closure mechanism 40 tightened on the underside of the cymbal 20, both of which actions can be substantially completed without touching the cymbal 20 itself. The wing nuts 26, felt ring, and washers can then be removed from the stand 22 while the cymbal 20 is covered by the protective cover 10 and the cymbal 20 can then be handled and removed using one's hands, as the cymbal 20 is protected from dirt and oils from one's hands. Alternatively, the cymbal 20 with the cymbal cover 10 can remain supported on the cymbal stand 22, if a user wishes to keep a drum set setup but does not want the cymbals 20 to be exposed to the elements or attract dust or dirt.

The cover 10 can also be easily removed from the cymbal when normal playing of the instrument is desired. To remove the cover 10 from a cymbal 20, the gathered closure mechanism 40 can be loosened or released to allow the opening 16 to stretch back over the circumferential edges of the cymbal 20. The aperture 50 can stretch once again to allow the aperture 50 to fit over the cymbal stand 22 and nut 26. By pulling the cymbal cover 10 away from the cymbal 20, the cymbal 20 can be released from the internal cavity 14 and through the opening 16. Removal of the cover 10 from the cymbal 20 can also occur while the cymbal 20 is disposed on the stand 22 or is free from the stand 22. When the cymbal 20 is disposed on the stand 22 from storage or the like, the washer and nut 26 can be applied to the stand 22 to secure the cymbal in place on the stand 22. One can then loosen the gathered closure mechanism 40 on the underside of the cymbal 20 such as by loosening a drawstring 30, and then slide the cover off of the cymbal 20 to the aperture 50, stretch the material at the aperture 50 over the washer, wing nut 26, and felt ring, and remove the same. Once the slider clip 32 is loosened, the cover 10 can hang down over the circumferential edges of the cymbal 20 and a user can grab more material without risking touching the cymbal 20 because the slack in the cover 10 has been released.

Use of the cover 10 can resist wear and damage to the cymbal 20. It can be used for storage, transport, or whenever cymbals 20 are exposed to the open air, finger oils, and dust, and can generally protect the cymbal 20 until the cymbal 20 is ready for use.

Due to the stretchable material and the low-friction nature of the inner surface of the body 12 facing the internal cavity 14, it takes little to no effort to pull on and take off the cover 10 from a cymbal 20, and in particular, the material is able to slide over the circumferential edges of the cymbal 20 such that there is no need to apply any force to pull it over the edges, which could otherwise result in fingerprint smudges and force against the cymbal. The stretchable and slippery nature of the material can also allow the cover 20 to slide along the flat and smooth surfaces of the cymbal 20 to give a trim fit and easy application and removal. The stretchy flexible nature of the cover 20 can also permit a faster on-and-off process.

The stretchable nature of the aperture 50 can allow for application and removal of the cover 10 while the cymbal 20 is supported on its stand 22. A user does not need to remove the washer, wing nut 26 or felt ring before applying or removing the cover 10, but rather, can stretch the aperture 50 over the same when applying or removing the same. Since the aperture is resilient, it can still provide coverage of the upper surface of the cymbal 20 around the stand 22. This can reduce or eliminate the need to touch the cymbal 20 with bare hands while setting up or taking down the percussion set.

The gathered closure mechanism 40 can allow for fuller coverage for the underside of the cymbal 20 and stays in place better for transportation and insertion into cymbal carrying bags. It can also prevent the cover 20 from shifting or slipping off in transit due to its tightening capabilities. This is particularly the case where a drawstring 30 with a slider clip 32 is used.

The drawstring 30 on the underside of the cymbal 20 can allow for a tight closure; the stretchable nature of the material of the body 12 can allow the aperture 50 to stretch around the washer and wing nut 26, as well as allow movement across the surface of the cymbal 20 to give some slack to allow the drawstring 30 to draw the opening 16 in to give the underside of the cymbal 20 more complete coverage. The elastic nature of the body 12's material allows for a tight fit around the cymbal 12, but the release of the gathered closure mechanism 40 can provide slack that can be released to provide material that a user can grab, thus reducing the necessity of touching the underside of the cymbal 20 with bare hands.

It will be understood that the body 12's material could be made to be lightweight for travel and that the body 12 could have at least one customizable graphic feature, including one or more colours, patterns or indicia such as a logo, label, name, initials, etc.

The foregoing is considered as illustrative only of the principles of the invention. Further, since numerous changes and modifications will readily occur to those skilled in the art, it is not desired to limit the invention to the exact construction and operation shown and described, and accordingly, all such suitable changes or modifications in structure or operation which may be resorted to are intended to fall within the scope of the claimed invention.

What is claimed is:

1. A cymbal cover comprising:
a resiliently stretchable, flexible cup-shaped body having a closed circular top and an open bottom defining an internal cavity and a bottom opening;
a resiliently stretchable aperture disposed on the closed circular top; and
a gathered closure mechanism adjacent the bottom opening.

2. The cymbal cover of claim 1 wherein the closed circular top comprises an unbroken base of material extending from the aperture to the outer diameter of the closed circular top.

3. The cymbal cover of claim 1 wherein the stretchable, flexible cup-shaped body comprises a single unitary base of material.

4. The cymbal cover of claim 1 wherein the stretchable, flexible cup-shaped body is made out of an 80%/20% blend of nylon/spandex.

5. The cymbal cover of claim 1 wherein the stretchable, flexible cup-shaped body is made out of a low-friction material.

6. The cymbal cover of claim 1 wherein a side portion of the cup-shaped body is sized to cover at least a majority of an underside of a cymbal when the gathered closure mechanism is engaged in a closed configuration.

7. The cymbal cover of claim 1 wherein when the gathered closure mechanism is engaged in a closed configuration, the bottom opening is drawn-in to define a bottom opening of a diameter sized to fit snugly around a cymbal stand.

8. The cymbal cover of claim 1 wherein the resiliently stretchable aperture is sized to fit snugly around a cymbal stand.

9. The cymbal cover of claim 1 wherein the resiliently stretchable aperture is made out of the same material as the resiliently stretchable, flexible cup-shaped body.

10. The cymbal cover of claim 1 wherein the resiliently stretchable aperture comprises a slit in the resiliently stretchable, flexible cup-shaped body.

11. The cymbal cover of claim 1 wherein the gathered closure mechanism comprises an elasticized portion adjacent and around the bottom opening.

12. The cymbal cover of claim 1 wherein the gathered closure mechanism comprises a drawstring.

13. The cymbal cover of claim 12 wherein the gathered closure mechanism further comprises a cord lock.

14. The cymbal cover of claim 1 wherein the gathered closure mechanism comprises both a drawstring and an elasticized portion adjacent and around the bottom opening.

15. The cymbal cover of claim 1 wherein the body has at least one customizable graphic feature.

16. A method of using a cymbal cover comprising the steps of:
providing a cymbal;
stretching a resiliently flexible cup-shaped body over the cymbal;
engaging a closure mechanism adjacent a bottom opening of the cup-shaped body to draw the bottom opening together on an underside of the cymbal.

17. The method of claim 16 further comprising the step of stretching an aperture disposed on a closed top of the cup-shaped body over at least one of a wing nut, a washer, and a cymbal stand.

18. The method of claim 16 wherein the step of engaging a closure mechanism comprises retracting an elastic band disposed adjacent and around the bottom opening.

19. The method of claim 16 wherein the step of engaging a closure mechanism comprises operating a drawstring and cord lock.

20. The method of claim 16 further comprising the step of removing the cymbal cover from the cymbal by:
releasing the closure mechanism, whereby slack is released in the cup-shaped body; and
gripping the slack in the cup-shaped body and pulling the cup-shaped body away from the cymbal.
